(19) United States
(12) Patent Application Publication
(10) Pub. No.: US 2005/0137882 A1
(43) Pub. Date: Jun. 23, 2005

(54) Method for authenticating goods

(76) Inventors: Don T. Cameron, Carlsbad, CA (US); Gary L. Oechsle, Vista, CA (US); Christopher S. Ladd, Mattapoisett, MA (US)

Correspondence Address: Edward A. Pennington, Esq.;Swidler Berlin Shereff Friedman, LLP, Suite 300, 3000 K Street, N.W., Washington, DC, 20007-5116, US

(21) Appl. No.: 10/736,641

(22) Filed: Dec. 17, 2003

(51) Int. Cl. G06F 17/60

(52) U.S. Cl. 705/1

(57) ABSTRACT

A method for authenticating goods is disclosed. The method includes providing a product to be authenticated, identifying relevant features of the product, comparing the features to predetermined manufacturing specifications, determining whether the features substantially conform to the manufacturing specifications, and reporting results of the determination. If the product is deemed to be authentic, an indication of the authentication is provided on the product and a certificate of authentication is provided.

### BACKGROUND OF THE INVENTION

1. Field of the Invention

The present invention relates to commerce. In particular, the present invention relates to authenticating goods for sale as being genuine.

2. Description of the Related Art

When purchasing a product, one decision the purchaser must make is to either buy a new product or a used product. The purchaser can also decide to buy from an authorized distributor or from another source, such as an original purchaser. The market for used products and products from non-authorized distributors has increased with the ever-increasing popularity of the internet as an avenue of commerce.

When buying a product from a manufacturer or an authorized distributor, the buyer may have a relatively high level of confidence that the product is authentic. For example, a purchaser buying a Scotty Cameron golf putter from an authorized Titleist® dealer will likely have a high level of confidence that the putter is actually an authentic Scotty Cameron putter. However, when buying from a non-authorized distributor, and especially from a seller known only through an internet auction site, the purchaser may not have a high level of confidence that the product is authentic. While many of the currently available internet sales/auction sites may have measures in place to prevent the sale of knock-off or counterfeit products, some number of these products likely are transacted.

Authentication may also be desired for other purposes. For example, collectors may wish to have their collections authenticated to protect their integrity and to assist in the valuation of their collections.

Thus, there is a need for a system and method of authenticating goods.

### SUMMARY OF THE INVENTION

The present invention relates to commerce, and more particularly, to authenticating goods for sale as being genuine. In a preferred embodiment, the golf equipment owner provides golf equipment to be authenticated. The equipment is preferably provided to an authorized authenticator, which may be the designer, employees of the designing company, or others who have been trained and authorized to perform authentication. The providing process may also include creation of a mailing label and/or a packing slip. This is preferably created through an automated process, such as through accessing and completing a fill-in form via the internet. This step also may notify the authenticator of the request for authentication.

The authenticator identifies relevant features of the equipment. These features may include physical dimensions, materials, finishes, manufacturer markings such as engravings or stampings, serial numbers, and/or other features. Any number of these features may be examined. The features will vary depending on the equipment product being examined.

The authenticator compares the features to predetermined manufacturing specifications. The comparison may include comparing multiple views of the equipment to specific predetermined specification. Contemplated views for the pictures include a front view of the product, a back view of the product, and a view of any distinguishing mark that may be present on the product. These latter pictures may serve as a “thumbprint” of the product and help uniquely identify the product. Exemplary distinguishing marks include, but are not limited to, hand-stamped characters and intricate design work. The views of the equipment may be compared to a previously prepared record of the equipment, such as previously taken pictures of the equipment. The equipment may also be compared to a similar product known to be authentic.

Based on the comparison, the authenticator determines whether the features substantially conform to the manufacturing specifications. This determination preferably includes accounting for wear due to normal use of the equipment.

The authenticator then reports the results of the determination. The report preferably includes making an indicia of the determination on the equipment and providing an authentication certificate. The certificate preferably includes a picture of the equipment, a seal, and a reference number associated with the equipment. The reference number is also preferably provided on the equipment itself. The authentication certificate preferably includes a seal. Preferred seals include stickers, holograms, embossments, and combinations thereof. The authenticator may also provide an indication of the condition of the equipment and indication of whether the equipment has been altered from its original condition. If the equipment has been altered, the authenticator may also explain how it has been altered.

### DESCRIPTION OF THE DRAWINGS

The present invention is described with reference to the accompanying drawings, in which like reference characters reference like elements, and wherein:

FIG. 1 shows a flowchart of a preferred method of the present invention;

FIG. 2 shows a flowchart of an automated ordering process;

FIG. 3 shows an exemplary examination certificate; and

FIG. 4 shows a flowchart of an internet auction facilitation procedure.

### DETAILED DESCRIPTION OF THE INVENTION

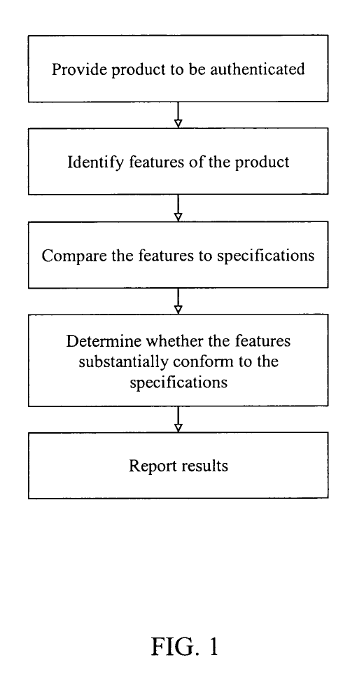

FIG. 1 shows a flowchart of a preferred method of the present invention. The method begins with providing a product, such as a piece of golf equipment, to be authenticated. The owner of the equipment may wish to have the product authenticated prior to selling it, so that the buyer can be assured that the product is genuine, or for his or her personal reasons. The product is preferably provided to an authorized authenticator. This may be the product designer, employees of the designing company, or others who have been trained and authorized to perform authentication. Use of trained authenticators facilitates authentication and makes the process easier for the product owner, since having multiple authenticators allows the authentication to be performed in multiple locations. The product may be provided in person or through a shipping carrier. If a shipping carrier is used, a mailing label may be generated as discussed below.

After the product has been provided, the authenticator identifies relevant features of the product. These features may comprise physical dimensions, materials, finishes, manufacturer markings such as engravings or stampings, serial numbers, and/or other features. Any number of these features may be examined. The features will vary depending on the specific product being examined. For example, the features of a Scotty Cameron Bullseye putter will have different features than a Scotty Cameron Futura® putter. It is contemplated that, in the case of a golf putter, one or more of the following criteria will be examined: shape, stamping, finish, paint fill, shaft, grip, and weight. Preferably, two or more of these criteria will be examined. More preferably, three or more of these criteria will be examined. Most preferably, all of these criteria will be examined. Pictures of the product may be taken as part of the identification procedure. Contemplated views for the pictures include a front view of the product, a back view of the product, and a view of any distinguishing mark that may be present on the product. These latter pictures may serve as a “thumbprint” of the product and help uniquely identify the product. Exemplary distinguishing marks include, but are not limited to, hand-stamped characters and intricate design work.

The relevant features of the product are compared to predetermined manufacturing specifications. The products are originally manufactured to meet these specifications, and are not released from the manufacturer if there is any significant deviation therefrom. Manufacturing specifications are retained as a matter of normal business procedure, so they are readily available for use in the authentication process. Pictures of a like product as originally manufactured may be used during the comparison procedure. Alternatively, pictures of the exact product being examined could be used, if such pictures were taken of the product prior to its distribution. Such pictures could be linked to the product by, for example, the product serial number. These pictures (of either sort) may be compared to any corresponding pictures taken during the identification procedure. The products may also be compared to a similar product known to be authentic.

A determination is then made whether the features substantially conform to the manufacturing specifications. Depending on the age of the product, the specific materials used to form the product, the amount of product use, etc., there may likely be some deviation between the original manufacturing specifications and the features exhibited by the product at the time of examination. Such deviations frequently occur during normal use of the product. For example, a golf putter may become nicked or otherwise marked or scratched through normal use thereof. The determination process will take these expected deviations into account. If the product is deemed to be authentic, it is entered into an authentic product registry and given a registration number. The entry in the registry will include a description of the product, the examination results, and the date of examination. If any pictures were taken of the product, copies thereof may also be included in the registry. If a product is examined multiple times, it will be entered into the registry and given a registration number for each examination. Thus, a particular product may have multiple registry entries and registration numbers associated therewith. Multiple entries regarding a product may be linked, such that a search for prior examinations will yield all such examinations.

There are varying categories of results of the examination. A first possible category is whether the product is authentic or fake. If, through the determination process, the authenticator determines that the product is an authentic article, the authentication report will so indicate. However, if the authenticator determines the product to be fake (that is, not made by the manufacturer indicated on the product, its packaging, etc.), the authentication report will so indicate.

A second possible category is whether or not the product has been altered from its original condition. If the product has been determined to be authentic and not altered, it may be given a rating such as “Authentic/Original.” If the product has been determined to be authentic and altered, it may be given a rating such as “Authentic/Altered.” Furthermore, if the product has been altered, it may be desirable to indicate how the product has been altered. Several aspects of a golf putter may be altered. Exemplary aspects include, but are not limited to, the grip, the shaft, the shaft band, the finish, and any engraving or stamping. An exemplary rating for an authentic and altered putter may be “Authentic/Altered (grip replaced).”

A third possible category (for an authentic product) is the product condition. Contemplated options include mint, good, fair, and poor. “Mint” indicates that the product is in brand new condition. “Good” indicates that the product is in near-mint condition. For example, a putter having some surface wear, a used grip, a used head cover, etc. would be in good condition. “Fair” indicates that the product is usable but has heavier wear. For example, a putter in playable condition with some surface wear and/or head dings and accessory wear would be fair condition. “Poor” indicates that the product has been badly damaged. For example, a putter with rust and/or more severe head dings would be in poor condition. If a product condition indicator is given, it is preferably accompanied by the examination date in order to give an indication of the likelihood that the product has been used or otherwise modified since being examined.

Alternatively, the examination results may be simply “Authentic” for an authentic and unaltered product and “Modified” for any other authentic product.

The results of the examination may be reported in a variety of ways. If the product is deemed to be authentic, a stamp may preferably be placed thereon. For example, if a golf putter is found to be authentic, the putter face may be stamped with the registration number, such as with a rubber ink stamp. The product owner may keep the stamp on the product, or may remove it if desired. If the owner is having the putter authenticated prior to selling it, the owner may likely keep the stamp on the club. If the owner is going to use the putter, however, he may wish to remove the stamped registration number.

In addition to providing an indicia of authenticity on the product itself, the report preferably also includes an authentication certificate. The certificate will include a description of the product, the examination results, and the product registration number. The certificate preferably also includes a listing of the product parts and their status (original, altered, repaired, etc.). Photographs of the product are also preferably included as part of the certificate. This will help ensure an issued certificate is not applied to a different product. A seal is also preferably included as part of the certificate. The seal preferably overlaps the pictures in order to deter the creation of fake certificates. The seal is selected based on the product condition. If the product is deemed to be authentic, original, and in mint condition (that is, the highest ranking), the seal preferably will be a hologram. A different seal will be used with any other examination result. Stickers may also be used with the holograms to indicate the product registration number. The holograms and stickers are preferably resistant to removal, such as containing cuts such that the seal will be destroyed if one attempts to remove it from the certificate. An additional form of the seal is an embossment that is pressed into the certificate, further deterring certificate forgeries. An embossment preferably is included with every authentication certificate for an authentic product.

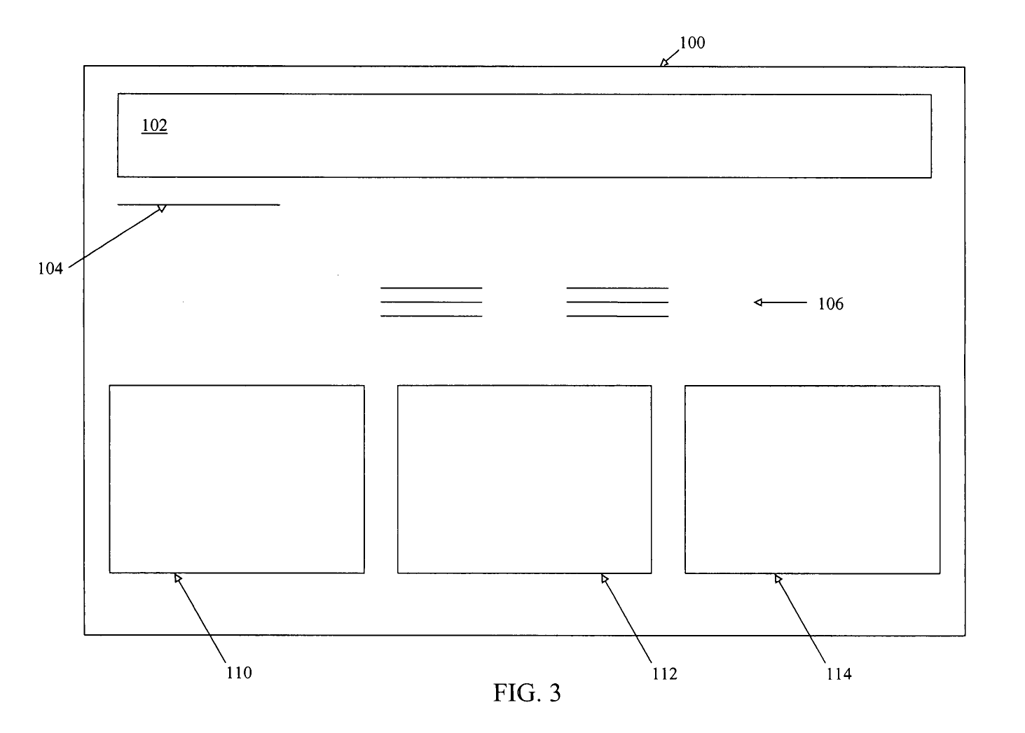

FIG. 3 shows an exemplary examination certificate 100. Certificate 100 includes an area 102 for providing a logo and other information regarding the product or authenticator. The registration number is provided in area 104 below the logo area 102. Additional information, such as the type of product examined, may also be provided here. The examined criteria and the results are provided in area 106. Exemplary information includes “Shape: Authentic” and “Stamping: Authentic.” Pictures of the examined product are provided at areas 110, 112, and 114. Other items, such as embossments and holograms, may also be included on certificate 100. Certificate 100 preferably may be color-coded based on the examination results. For example, a certificate for an authentic and unaltered product may be red, a certificate for an authentic and slightly modified product may be green, etc. This color-coding would serve as an additional precaution against certificate modification.

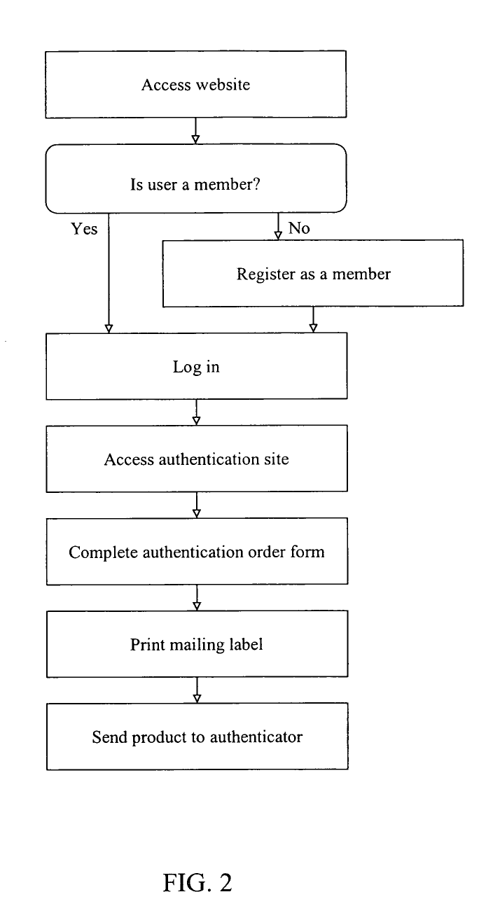

The providing process may include creating a mailing label to ship the product to the authenticator. This creating is preferably automated, such as through accessing and completing a fill-in form via the internet, such as through the Scotty Cameron website (www.scottycameron.com). FIG. 2 shows a flowchart of this process. After accessing the main website, the product owner signs in. If the owner has not previously registered as a member, he does so. This entails entering personal information that can later be used to populate on-line forms.

Once signed in, the owner accesses the authentication portion of the website and clicks on an authentication link to initiate the process. A form is then displayed, into which the owner can insert the required information. For example, the owner will enter information regarding the product and the shipping address. Optional fields, such as insurance options and mail carrier options, will also be available. The owner will also be given the opportunity to enter information for additional products to be examined. Thus, the owner may submit several pieces of equipment to be examined in one shipment. Once the owner has completed the form, the owner clicks a submit button. If all of the required information has not been provided, the owner is so notifying and given a chance to provide the missing information.

Once all of the information has been submitted, the information is submitted to the authenticator and a mailing label is generated. A packing slip may also be generated. The mailing label preferably will be based on the mailing options selected by the owner during completion of the authentication order form. The owner then prints the mailing label and affixes it to the package, and sends the product to the authenticator. If the owner has opted to use a commercial carrier, such as Federal Express, the generated mailing label will conform with that carrier's requirements. Regardless of the mailing carrier chosen, the website will generate a control number that is associated with the owner's order. This number is preferably placed on the mailing label and/or packing slip so that the authenticator can easily associate the product with the owner and associated information. The owner can use this number to obtain the current status of his order, such as through the authentication website. For example, by accessing the authentication website and entering the control number in the appropriate place, the owner will first be able to determine when the product has been received by the authenticator. After the authenticator has determined that the correct product has been shipped and matched to an order, the product will be placed in a queue to be examined. As an initial step of the examination process, the website will be updated to indicate that the examination has begun or is in process. Upon completion of the examination, the website will again be updated to indicate the examination is complete. Additionally, the website will provide the results of the examination. Finally, the product will be shipped back to the owner, and the website will be updated to so indicate.

The examination results will be available via the website for an extended period of time. The results will indicate the type of product, the examination results, and, optionally, the date of examination. Thus, a person contemplating the purchase of a product may access the website, enter the control number (which could be provided by the product owner), and view the examination, thereby being reassured that the product is authentic. The examination results can be searched by examination control number and/or by the product type. For example, instead of entering a control number, a searcher could enter “Newport” to view examination results of all the examined Scotty Cameron Newport® putters.

As discussed above, when purchasing a product from an unknown seller, such as via an internet auction website, the purchaser may not have a high level of confidence that the product is authentic. An additional feature of the method of authentication of the present invention facilitates ecommerce by providing an encoded text or registry engine code that a product owner can paste into an auction website listing. The text is hyperlinked directly to a page within the authentication website that provides the examination results for the product being sold. The text itself is a short phrase, such as “Link to Certificate of Authentication” or “Scotty Cameron Authentication Certificate.” This is more beneficial than simply copying and pasting the uniform resource locator (URL) of the authentication page, since those can be quite long and do not necessarily indicate the nature of the linked website.

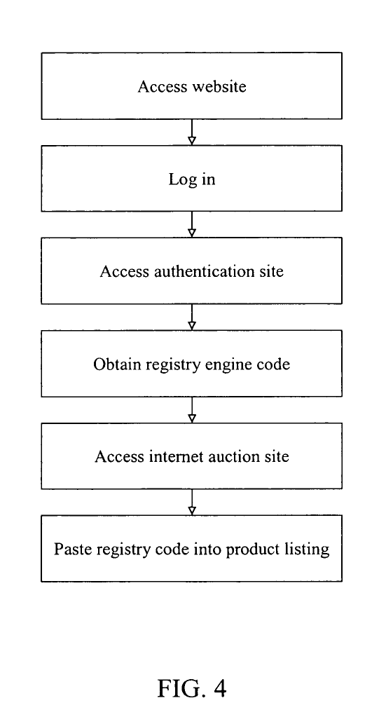

FIG. 4 shows a flowchart of this process. After accessing the main website, the product owner signs in. If the owner has not previously registered as a member, he does so. Once signed in, the owner accesses the authentication portion of the website and clicks on an auction link, which provides the encoded text. The encoded text may be provided in a pop-up window or dialog box, or as a part of the existing page. Alternatively, the encoded text can be provided automatically as a routine step in the authentication process without having to specifically request it.

Once the encoded text has been provided and copied by the product owner, the product owner accesses the desired internet auction website and creates a product listing according to that website's procedures. When providing a description of the product, the owner pastes the encoded text into the product description. When a potential buyer is reviewing the product description, he can click on the encoded text to view the authentication certificate and related information, thereby being reassured that the product is genuine. It may be preferred that the encoded text open the authentication webpage in a new window so that the potential buyer can simultaneously view both the auction website listing and the authentication webpage.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. For example, while the disclosure has focused on golf equipment, the system and method of the present invention could equally be used with any other type of good or service. Furthermore, the method steps have been described in an order to facilitate explanation thereof. However, the steps should not be construed as having to be performed in the order described. Thus the present invention should not be limited by the above-described exemplary embodiments, but should be defined only in accordance with the following claims and their equivalents.

1. A method of authenticating golf equipment, comprising:
providing the golf equipment to be authenticated;
identifying relevant features of the equipment;
comparing said features to predetermined manufacturing specifications;
determining whether said features substantially conform to said manufacturing specifications; and
reporting results of said determining.

2. The method of claim 1, wherein said providing includes providing the equipment to an authorized authenticator.

3. The method of claim 1, wherein said identifying includes identifying one or more features selected from the group consisting of physical dimensions, materials, finishes, manufacturer markings, serial numbers, and combinations thereof.

4. The method of claim 1, wherein said identifying includes identifying one or more features selected from the group consisting of shape, stamping, finish, paint fill, shaft, grip, and weight.

5. The method of claim 4, wherein said identifying includes identifying two or more features selected from the group.

6. The method of claim 1, wherein said identifying includes identifying shape, stamping, finish, paint fill, shaft, grip, and weight.

7. The method of claim 4, wherein said identifying includes identifying three or more features selected from the group.

8. The method of claim 1, wherein said comparing includes:
comparing a first view of the equipment to a predetermined specification; and
comparing a second view of the equipment to a predetermined specification.

9. The method of claim 8, wherein said comparing further includes comparing a third view of the equipment.

10. The method of claim 9, wherein said third view is of a distinguishing mark on the equipment.

11. The method of claim 1, wherein said comparing includes comparing the equipment to a previously prepared record of the equipment.

12. The method of claim 11, wherein said comparing further includes comparing the equipment to previously taken pictures of the equipment.

13. The method of claim 1, wherein said determining includes accounting for wear due to normal use of the equipment.

14. The method of claim 1, wherein said reporting includes making an indicia of said determining on the equipment.

15. The method of claim 1, wherein said reporting includes providing an authentication certificate.

16. The method of claim 15, wherein said reporting includes providing an authentication certificate including:
a picture of the equipment;
a seal; and
a reference number associated with the equipment.

17. The method of claim 16, wherein said reporting further includes providing said reference number on the equipment.

18. The method of claim 16, wherein said reporting further includes providing an authentication certificate including a seal selected from the group consisting of a sticker, a hologram, an embossment, and a combination thereof.

19. The method of claim 1, wherein said reporting includes providing an indication of the condition of the equipment.

20. The method of claim 1, wherein said reporting includes providing an indication of whether the equipment has been altered from its original condition.

21. The method of claim 20, wherein, if the equipment has been altered from its original condition, said reporting further includes providing an indication of how the equipment has been altered.

22. The method of claim 1, wherein said reporting includes providing a certificate, said certificate being color-coded based on said results.

23. The method of claim 1, wherein said providing includes creating a mailing label through an automated process.

24. The method of claim 22, wherein said creating further includes creating a packing slip.

25. The method of claim 22, wherein said creating includes using the internet.

26. The method of claim 22, wherein said creating includes notifying the authenticator of the request for authentication.

27. The method of claim 1, further comprising providing an encoded text link to a website that provides said results.
